(19) United States
(12) Patent Application Publication
(10) Pub. No.: US 2019/0153358 A1
(43) Pub. Date: May 23, 2019

(54) Laundry Compositions Having Broad Spectrum Stain Removal

(71) Applicant: Henkel IP & Holding GmbH, Duesseldorf (DE)

(72) Inventors: Michelle A. Piombino, West Haven, CT (US); Calogero A. Distefano, Milford, CT (US); Cynthia L. Moser, Wilton, CT (US)

(73) Assignee: Henkel IP & Holding GmbH, Duesseldorf (DE)

(21) Appl. No.: 16/198,254

(22) Filed: Nov. 21, 2018

Related U.S. Application Data
(60) Provisional application No. 62/589,310, filed on Nov. 21, 2017.

(51) Int. Cl. C11D 3/386; C11D 11/00; C11D 7/26; C11D 1/83; C11D 17/04

(52) U.S. Cl. CPC C11D 3/38618; C11D 11/0017; C11D 1/22; C11D 1/83; C11D 17/043; C11D 7/265

(57) ABSTRACT

Washing or cleaning compositions suitable for removing proteinaceous and non-proteinaceous stains; the compositions include a surfactant and enzyme, wherein the compositions have an alkaline pH; and the invention further relates to uses of such compositions.

### FIELD OF THE INVENTION

The present invention relates to the field of household and industrial cleaning, particularly in applications for cleaning laundry. The invention relates to washing or cleaning compositions comprising a surfactant and enzyme, wherein the compositions have an alkaline pH. The invention further relates to uses of such compositions.

### BACKGROUND OF THE INVENTION

Enzyme-containing detergents were introduced in the early part of the 1900s but were not used to a great degree until the 1960s, when thermally and alkali robust bacterial enzymes became available. One of the main applications for enzyme-containing detergents is for cleaning laundry. Laundry detergent formulations are complex, reflecting the diverse demands of the application. In general, laundry detergents contain, in addition to enzymes, many components such as builders, defoamers, anti-redeposition agents, soil release polymers, biocidal agents, perfumes, dyes, pH buffering agents, surfactants, water-softening agents, solubilizers, stain-removing polymers, bleaches, and brighteners.

Despite the availability of a wide variety of laundry detergent formulations, effectively removing proteinaceous (e.g., blood, grass, milk, and egg) and nonproteinaceous stains from fabrics remains an unsolved problem for consumers. Detergent manufactures have attempted to incorporate varying degrees of proteases into laundry detergent formulations for removing proteinaceous stains. In today's market, most liquid detergents with enzymatic stain removal systems are formulated at a neutral to slightly alkaline pH (e.g., pH 7.2-8.2). U.S. Pat. No. 8,455,424 discloses a washing or cleaning composition that contains a polypeptide having protease activity, where the preferred washing occurs in a pH range of pH 8-9 for the liquid composition, and pH 9-11 for a powder composition.

Though the range of pH 7.2-8.2 is preferred for enzymatic activity, it is not an ideal pH range for surfactants and/or bleaches contained in the formulations, which favor a higher pH range (e.g., pH 9-12) for optimum cleaning performance. A need therefore exists for washing or cleaning compositions comprising proteases that are stable at higher pH ranges.

The present inventors have discovered novel high alkaline (e.g., pH 12) proteases containing washing or cleaning compositions, which surprisingly not only can effectively remove proteinaceous stains, but also can effectively remove nonproteinaceous stains (e.g., mud, coffee, chocolate ice cream, BBQ sauce, and grape juice).

### BRIEF SUMMARY OF THE INVENTION

A first aspect of the disclosure relates to a washing or cleaning composition, comprising:

(a) a surfactant; and
(b) a protease,
wherein the composition has an alkaline pH.
The composition is suitable for removing proteinacous and non-proteinaceous stains from a soiled fabric.

The washing or cleaning composition is in a solid, liquid, gel, or paste form, preferably, in a solid form.

In one embodiment, the washing or cleaning composition has a pH between about pH 9 and about pH 12.

The surfactant of the washing or cleaning composition is selected from the group consisting of an anionic surfactant, a cationic surfactant, a nonionic surfactant, a zwitterionic surfactant, an ampholytic surfactant, and a combination thereof.

In one embodiment, composition contains an anionic surfactant. Suitable anionic surfactants can be selected from the group consisting of a polyethoxylated alcohol sulfate, a water soluble salt of an alkyl benzene sulfonate having between 8 and 22 carbons in the alkyl group, an alkali metal salt of C₁₀₋₁₆ alkyl benzene sulfonic acids, a linear alkyl benzene sulfonate, a sodium or potassium linear straight chain alkylbenzene sulfonate, a salt of alkylsulfosuccinic acid, a fatty acid derivative of amino acids, a saturated fatty acid soap, and a combination thereof.

In another embodiment, composition contains a nonionic surfactant. Suitable non-ionic surfactants can be selected from the group consisting of an alkoxylated, ethoxylated, or propoxylated primary alcohol having from 8 to 18 carbon atoms and 1 to 12 moles of ethylene oxide (EO) and/or from 1 to 10 moles of propylene oxide (PO) per mole of alcohol, a fatty alcohol ethoxylate having more than 12 EO, an alkoxylated amine, an alkyl polyglycoside, an alkoxylated, ethoxylated, or ethoxylated and propoxylated fatty acid alkyl ester having 1 to 4 carbon atoms in the alkyl chain, an amine oxide, an alcohol ethoxylate, a nonylphenol ethoxylate, an alkylpolyglycoside, an alkyldimethylamineoxide, an ethoxylated fatty acid monoethanolamide, a fatty acid monoethanolamide, a fatty acid (polyhydroxyalkanol)amide, a N-acyl-N-alkyl derivative of glucosamine, and a combination thereof.

In one embodiment, the surfactant is an ethoxylated primary alcohol having 8 to 18 carbon atoms and an average of 1 to 12 mol ethylene oxide (EO) per mol of alcohol, or is a C₁₂-C₁₅ alcohol ethoxylate 3EO, a C₁₂-C₁₅ alcohol ethoxylate 7EO, or a combination thereof.

In each of the embodiments above, the surfactant is present in a cleaning effective amount. In one embodiment, the surfactant is present in an amount of about 5 to about 25% by weight. In some embodiments, a combination of an anionic surfactant and a non-ionic surfactant are employed in the composition.

In each of the embodiments above, the protease can be present in an amount of about 0.1 to about 5% by weight.

In another embodiment, the washing or cleaning composition additionally comprises one or more of a defoamer, an anti-redeposition agent, a soil release polymer, a detergency builder, a biocidal agent, an enzyme, a perfume, a dye, a pH buffering agent, an optical brightener, a bitter agent, a water-softening agent, a bleach, a solubilizer, and a stain-removing polymer.

Suitable defoamers include a polyalkoxylated alkanolamide, amide, an amine oxide, a betaine, a sultaine, a C₈-C₁₈ fatty alcohol, a cocofatty acid, a soap of natural or synthetic origin having a high proportion of C₁₈ to C₂₄ fatty acid, an organopolysiloxane and mixture thereof with microfine, a paraffin, a wax, a microcrystalline wax, and mixtures thereof with a silanated silicic acid or a bis-fatty acid alkylenediamide. Defoamer is typically present in an amount of about 0.1 to about 5% by weight.

In another embodiment, the washing or cleaning composition is formulated to be suitable for use in a laundering method for removing soils from fabric. Compositions of the present disclosure remove both proteinaceous and non-proteinaceous stains.

Proteinaceous stains include, but are not limited to blood, grass, milk, eggs, ink, body soils, baby formula, baby food, bodily fluids, cream, gelatin, cheese, pudding, school glue, or combinations thereof.

Non-proteinaceous stains include, but are not limited to chocolate ice cream, coffee, dust sebum, grape juice, BBQ sauce, mud, alcoholic beverages, berries, fruit preserves, tomato juice, vegetable juice, maple syrup, molasses, tea, toothpaste, wine, or combinations thereof.

In certain embodiments, the washing or cleaning compositions are provided in a unit dose, for example, a pouch. In this aspect, the unit dose comprises:

(a) a washing or cleaning composition as described above; and
(b) a water-soluble film that forms one or more pouches encasing the cleaning composition.

In another embodiment, the invention provides a method of removing proteinaceous and non-proteinaceous stains from a soiled fabric, comprising:

(a) placing a soiled fabric into a washing chamber;
(b) placing a washing or cleaning composition into the chamber; and
(c) introducing water into the chamber and washing the fabric in an aqueous environment such that the washing or cleaning compositions contact the fabric and remove the stains from the fabric.

In another embodiment, the washing or cleaning composition is placed in to the chamber prior to or after introducing water into the chamber.

In another embodiment, the chamber is a washing machine, a tergetometer, or an equivalent device.

In another embodiment, the method comprises removing stains by hand washing.

### DETAILED DESCRIPTION OF THE INVENTION

The following description provides specific details, such as materials and quantities, to provide a thorough understanding of the present invention. The skilled artisan, however, will appreciate that the present invention can be practiced without employing these specific details. Indeed, the present invention can be practiced in conjunction with processing, manufacturing or fabricating techniques conventionally used in the detergent industry.

As used herein, “a,” “an,” or “the” means one or more unless otherwise specified.

Open terms such as “include,” “including,” “contain,” “containing” and the like mean “comprising”.

The term “about” as used herein, includes the recited number ±10%.

“Washing or cleaning composition” is defined as any substance or preparation containing an enzyme of the present disclosure and surfactant intended for washing or cleaning processes. Washing or cleaning compositions may be in a solid, liquid, gel, or paste form and can be used for household, institutional, or industrial purposes. In one embodiment, the washing composition is designed for use in a home laundry machine. In another embodiment, the composition is designed for use in a commercial laundry machine.

### Washing or Cleaning Compositions

In a first aspect, the disclosure relates to a washing or cleaning composition suitable for removing proteinacous and non-proteinaceous stains from a soiled fabric, comprising:

(a) a surfactant; and
(b) a protease,
wherein the composition has an alkaline pH.

In one embodiment, the washing or cleaning composition is in a solid, liquid, gel, or paste form, preferably, in a liquid form.

In some embodiments, the washing or cleaning composition has a pH between about 9 and about 12. In one embodiment, the pH is about 9 to about 10. In another embodiment, the pH is about 10 to about 11. In another embodiment, the pH is about 11 to about 12. In one embodiment, the pH is about 9, 10, 11, or 12.

In some embodiments, the surfactant of the washing or cleaning composition comprises an anionic surfactant, a cationic surfactant, a nonionic surfactant, a zwitterionic surfactant, an ampholytic surfactant, or a combination thereof. In some embodiments, the surfactant comprises an anionic surfactant, a nonionic surfactant, or a mixture thereof.

The washing or cleaning composition can comprise about 1% by weight to about 45% by weight, about 3% by weight to about 30% by weight, or about 3% by weight to about 19% by weight of one or more surfactants. In some embodiments, the washing or cleaning composition comprises about 1% by weight to about 3% by weight, about 3% by weight to about 5% by weight, about 5% by weight to about 10% by weight, about 5 by weight to about 20% by weight, about 5% by weight to about 30% by weight, about 5% by weight to about 40% by weight, about 6% by weight to about 10% by weight, about 6% by weight to about 40% by weight, about 10% by weight to about 20% by weight, about 10% by weight to about 30% by weight, about 10% by weight to about 40% by weight, about 20% by weight to about 30% by weight, about 20% by weight to about 40% by weight, or about 30% by weight to about 40% by weight, about 20% by weight to about 45% by weight, about 30% by weight to about 45% by weight, or about 40% by weight to about 45% by weight of at least one surfactant. In another embodiment, the washing or cleaning composition comprises about 3% by weight, 5% by weight, 10% by weight, 15% by weight, 18% by weight, 19% by weight, 20% by weight, 25% by weight, 30% by weight, 35% by weight, 40% by weight, or 45% by weight of one or more surfactants.

In some embodiments, one or more surfactants comprise an anionic surfactant in an amount of about 2% by weight to about 18% by weight and a nonionic surfactant in an amount of about 0.1% by weight to about 18% by weight.

### Surfactants

The washing or cleaning composition of the present disclosure can comprise an anionic surfactant, a cationic surfactant, a nonionic surfactant, a zwitterionic surfactant, an ampholytic surfactant, or a combination thereof. In certain embodiments, an anionic surfactant is employed. In other embodiments, a non-ionic surfactant is employed. In yet other embodiments, a mixture of an anionic surfactant and a non-ionic surfactant is employed.

### Anionic Surfactants

Suitable anionic surfactants include all of the anionic surfactants that are suitable for washing or cleaning compositions, including, but not limited to surfactants that contain a long chain hydrocarbon hydrophobic group in their molecular structure and a hydrophilic group, i.e., water solubilizing group including salts such as carboxylate, sulfonate, sulfate or phosphate groups. Suitable anionic surfactant salts include sodium, potassium, calcium, magnesium, barium, iron, ammonium and amine salts. Suitable anionic surfactants include the alkali metal, ammonium and alkanol ammonium salts of organic sulfuric reaction products having in their molecular structure an alkyl, or alkaryl group containing from 8 to 22 carbon atoms and a sulfonic or sulfuric acid ester group. Examples of such anionic surfactants include water soluble salts of alkyl benzene sulfonates having between 8 and 22 carbon atoms in the alkyl group, alkyl ether sulfates having between 8 and 22 carbon atoms in the alkyl group. It is understood in the art that frequently a particular surfactant will include molecules having a blend of alkyl-containing portions, and that the carbon number in the chains is frequently expressed as an average number of carbon atoms in the alkyl group.

In one embodiment, the anionic surfactant comprises an alkali metal salt of C₁₀₋₁₆ alkyl benzene sulfonic acids, or C₁₁₋₁₄ alkyl benzene sulfonic acids. In one embodiment, the alkyl group is linear. Such linear alkyl benzene sulfonates are known as “LAS.” Alkyl benzene sulfonates, and particularly LAS, are well known in the art. Other suitable anionic surfactants include: sodium and potassium linear straight chain alkyl benzene sulfonates in which the average number of carbon atoms in the alkyl group is from 11 to 14. Sodium C₁₁₋₁₄ e.g., C₁₂, LAS is one suitable anionic surfactant for use herein.

Other suitable anionic surfactants include polyethoxylated alcohol sulfates, such as those sold under the trade name CALFOAM® 303 (Pilot Chemical Company, California). Such materials, also known as alkyl ether sulfates or alkyl polyethoxylate sulfates, are those which correspond to the formula: R′—O—(C₂H₄O)ₙ—SO₃M; wherein R′ is a C₈-C₂₀ alkyl group, n is from 1 to 20, and M is a salt-forming cation; alternatively, R′ is C₁₀-C₁₈ alkyl, n is from 1 to 15, and M is sodium, potassium, ammonium, alkylammonium, or alkanolammonium. In another embodiment, R′ is a C₁₂-C₁₆, n is from 1 to 6 and M is sodium. The alkyl ether sulfates will generally be used in the form of mixtures comprising varying R′ chain lengths and varying degrees of ethoxylation. Frequently, such mixtures will inevitably also contain some unethoxylated alkyl sulfate materials, i.e., surfactants of the above ethoxylated alkyl sulfate formula wherein n=0. Unethoxylated alkyl sulfates may also be added separately to the compositions of this invention and used as or in any anionic surfactant component which may be present. Suitable unalkoyxylated, e.g., unethoxylated, alkyl ether sulfate surfactants are those produced by the sulfation of higher C₈-C₂₀ fatty alcohols. Conventional primary alkyl sulfate surfactants have the general formula of: ROSO₃M⁺, wherein R is typically a linear C₈-C₂₀ hydrocarbyl group, which may be straight chain or branched chain, and M is a water solubilizing cation; alternatively, R is a C₁₀-C₁₅ alkyl, and M is alkali metal. In one embodiment, R is C₁₂-C₁₄ and M is sodium.

In one embodiment, the anionic surfactant is at least one α-sulfofatty acid ester. Such a sulfofatty acid is typically formed by esterifying a carboxylic acid with an alkanol and then sulfonating the α-position of the resulting ester. The α-sulfofatty acid ester is typically of the following formula (I):

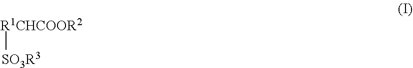

wherein R¹ is a linear or branched alkane, R² is a linear or branched alkane, and R³ is hydrogen, a halogen, a mono-valent or di-valent cation, or an unsubstituted or substituted ammonium cation. R¹ can be a C₄ to C₂₄ alkane, including a C₁₀, C₁₂, C₁₄, C₁₆ and/or C₁₈ alkane. R² can be a C₁ to C₈ alkane, including a methyl group. R³ is typically a mono-valent or di-valent cation, such as a cation that forms a water-soluble salt with the α-sulfofatty acid ester (e.g., an alkali metal salt such as sodium, potassium or lithium). The α-sulfofatty acid ester of formula (I) can be a methyl ester sulfonate, such as a C₁₆ methyl ester sulfonate, a C₁₈ methyl ester sulfonate, or a mixture thereof. In another embodiment, the α-sulfofatty acid ester of formula (I) can be a methyl ester sulfonate, such as a mixture of C₁₂-C₁₈ methyl ester sulfonates.

More typically, the α-sulfofatty acid ester is a salt, such as sodium or potassium salt. The α-sulfofatty acid ester can be a sodium methyl ester sulfonate, such as a sodium C₈-C₁₈ methyl ester sulfonate.

In one embodiment, the anionic surfactant is an alkyl ether sulfate of formula:

R⁴O(CH₂CH₂O)ₙSO₃M

where R⁴ is an alkyl group of 8 to 22 carbon atoms, n ranges from 1 to 10, especially 2 to 8, and M is a solubilizing cation (e.g., Na⁺, K⁺, Li⁺, NH₄⁺). In one embodiment, the alkyl ether sulfate is sodium lauryl ether sulphate (SLES).

Examples of other anionic surfactants are disclosed in U.S. Pat. No. 3,976,586, the disclosure of which is incorporated by reference herein.

### Zwitterionic Surfactants

In some embodiments, the washing or cleaning composition may comprise a zwitterionic surfactant. Suitable zwitterionic surfactants can be broadly described as derivatives of secondary and tertiary amines, derivatives of heterocyclic secondary and tertiary amities, or derivatives of quaternary ammonium, quaternary phosphonium or tertiary sulfonium compounds, such as those disclosed in U.S. Pat. No. 3,929,678, which is incorporated by reference herein.

### Nonionic Surfactants

Suitable nonionic surfactants include all of the anionic surfactants that are suitable for washing or cleaning compositions, including, but not limited to alkoxylated fatty alcohols, ethylene oxide (EO)-propylene oxide (PO) block polymers, polyalkoxylated alkanolamides and amine oxide surfactants. Suitable for use in the washing or cleaning compositions herein are those nonionic surfactants which are normally liquid.

Alkoxylated fatty alcohols (or alcohol alkoxylate) nonionic surfactants correspond to compounds of the general formula of: R⁵(CₘH₂ₘO)ₙOH, wherein R⁵ is a C₈-C₁₆ alkyl group, m is from 2 to 4, and n ranges from 2 to 12; preferably, R⁵ is an alkyl group, which may be linear or branched, that contains from 9 to 15 carbon atoms, or from 10 to 14 carbon atoms. In one embodiment, the alkoxylated fatty alcohols will be ethoxylated materials (i.e., m is 2) that contain from 2 to 12, or 3 to 10, EO moieties per molecule (i.e., n is 2-12 or 3-10). In one embodiment, the alcohol alkoxylate nonionic surfactants are ethoxylated primary alcohol having 8 to 18 carbon atoms and an average of 1 to 12 mole ethylene oxide (EO) per mole of alcohol. For example, the alcohol alkoxylate nonionic surfactants contain a C₁₂-C₁₅ alcohol ethoxylate 3EO, a C₁₂-C₁₅ alcohol ethoxylate 7EO, or a combination thereof.

The alkoxylated fatty alcohol materials useful in the liquid compositions herein will frequently have a hydrophilic-lipophilic balance (HLB) which ranges from 3 to 17, from 6 to 15, or from 8 to 15. Alkoxylated fatty alcohol nonionic surfactants have been marketed under the tradenames Neodol and Dobanol by the Shell Chemical Company. Other suitable alkoxylated alcohol nonionic surfactants is Plurafac® SLF-180 (available from BASF), or Triton® DF-16 (available from Dow Chemical Company).

Another nonionic surfactant suitable for use includes ethylene oxide (EO)-propylene oxide (PO) block polymers, such as those marketed under the tradename Pluronic®. These materials are formed by adding blocks of ethylene oxide moieties to the ends of polypropylene glycol chains to adjust the surface-active properties of the resulting block polymers.

Other suitable nonionic surfactants include polyalkoxylated alkanolamides, which are generally of the following formula (III):

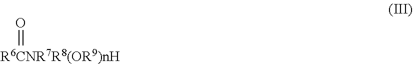

wherein R⁶ is an alkane or hydroalkane, R⁷ and R⁹ are alkanes and n is a positive integer. R⁶ is typically an alkane containing 6 to 22 carbon atoms. R⁷ is typically an alkane containing 1-8 carbon atoms. R⁹ is typically an alkane containing 1 to 4 carbon atoms, and more typically an ethyl group. The degree of polyalkoxylation (the molar ratio of the oxyalkyl groups per mole of alkanolamide) typically ranges from about 1 to about 100, or from about 3 to about 8, or about 5 to about 6. R⁸ can be hydrogen, an alkane, a hydroalkane group or a polyalkoxylated alkane. The polyalkoxylated alkanolamide is typically a polyalkoxylated mono- or di-alkanolamide, such as a C₁₆ and/or C₁₈ ethoxylated monoalkanolamide, or an ethoxylated monoalkanolamide prepared from palm kernel oil or coconut oil.

Yet another nonionic surfactant useful herein comprises the amine oxide surfactants. Amine oxides are often referred to in the art as “semi-polar” nonionics, and have a general formula: R^{a}(EO)ₓ(PO)_{y}(BO)_{z}N(O)(CH₂R^{b})₂.qH₂O, wherein, R^{a} is a relatively long-chain hydrocarbyl moiety which can be saturated or unsaturated, linear or branched, and can typically contain from 8 to 20, from 10 to 16 carbon atoms, or a C₁₂-C₁₆ primary alkyl; R^{b} is a short-chain moiety such as a hydrogen, methyl and —CH₂OH; EO is ethyleneoxy, PO is propyleneneoxy and BO is butyleneoxy, and each of x, y, and z is an integer, ranging from 0 to 20.

In some embodiments, the washing or cleaning composition of the present disclosure comprises a high surfactant concentration system comprising an anionic surfactant, a nonionic surfactant, or mixtures thereof. In some embodiments, the washing or cleaning composition of the invention comprises a high surfactant concentration system comprising a combination of an anionic surfactant and a nonionic surfactant. In particular, the anionic surfactant is alkyl benzene sulfonic acid, and the nonionic surfactant is a C₁₂-C₁₅ alcohol ethoxylate 3EO or a C₁₂-C₁₅ alcohol ethoxylate 7EO, or a mixture thereof.

In some embodiments, the washing or cleaning composition comprises a low surfactant concentration system comprising an anionic surfactant, a nonionic surfactant, or mixtures thereof. In some embodiments, the washing or cleaning composition of the invention comprises a high surfactant concentration system comprising a combination of an anionic surfactant and a nonionic surfactant. In particular, the anionic surfactant is alkyl benzene sulfonic acid, and the nonionic surfactant is a C₁₂-C₁₅ alcohol ethoxylate 3EO, or a C₁₂-C₁₅ alcohol ethoxylate 7EO, or a mixture thereof.

The washing or cleaning composition may comprise a surfactant system containing from about 3% by weight to about 25% by weight, or from about 5% by weight to about 20% by weight of at least one anionic surfactant. The washing or cleaning composition may comprise a surfactant system containing and from about 1% by weight to about 20% by weight, or from about 5% by weight to about 15% by weight of at least one nonionic surfactant.

In some embodiments, the washing or cleaning composition comprises from about 3% by weight to about 25%, or from about 5% by weight to about 20% by weight of an anionic surfactant selected from the group consisting of alkylbenzene sulfonic acid, alkyl benzene sulfonate, an α-sulfofatty acid ester salt, an alkyl ether sulfate, and mixtures thereof. In a particular embodiment, the washing or cleaning composition comprises from about 5% by weight to about 25% by weight of an anionic surfactant selected from the group consisting of alkylbenzene sulfonic acid, alkyl benzene sulfonate, methyl ester sulfonate, sodium lauryl ether sulphate, and mixtures thereof,

In some embodiments, the washing or cleaning composition comprises from about 1% by weight to about 20% by weight, or from about 5% by weight to about 15% by weight of a nonionic surfactant, which comprises an alcohol ethoxylate.

In a particular embodiment, the washing or cleaning composition comprises from about 3% by weight to about 25% by weight of an anionic surfactant selected from the group consisting of alkylbenzene sulfonic acid, alkyl benzene sulfonate, methyl ester sulfonate, sodium lauryl ether sulphate, and mixtures thereof, and from about 1% by weight to about 20% by weight of a nonionic surfactant, which comprises an alcohol ethoxylate.

### Cationic Surfactants

In some embodiments, the washing or cleaning composition may optionally comprise one or more cationic surfactants. Suitable cationic surfactants are quaternary ammonium surfactants. Suitable quaternary ammonium surfactants are selected from the group consisting of mono C₆-C₁₆, or C₆-C₁₀ N-alkyl or alkenyl ammonium surfactants, wherein the remaining N positions are substituted by methyl, hydroxyethyl or hydroxypropyl groups. Another cationic surfactant is C₆-C₁₈ alkyl or alkenyl ester of a quaternary ammonium alcohol, such as quaternary chlorine esters. In another embodiment, the cationic surfactants have the general formula: X⁻[(N⁺R¹¹CH₃CH₃)—(CH₂CH₂O)ᵤH], wherein R¹¹ is C₈-C₁₈ hydrocarbyl and mixtures thereof, or C₈₋₁₄ alkyl, or C₈, C₁₀ or C₁₂ alkyl, u is an integer, ranging from 1 to 20, and X is an anion such as chloride or bromide.

### Enzymes

The washing or cleaning composition of the present disclosure comprises an enzyme present in an amount of about 0.01% to 5.0% by weight, about 0.05% to 4.5% by weight, about 0.1% to 4.0% by weight, about 0.15% to 3.5% by weight, about 0.2% to 3.0% by weight, about 0.25% to 2.5% by weight, about 0.3% to 2.0% by weight, about 0.35% to 1.5% by weight, about 0.4% to 1.0% by weight, or about 0.5% to 1.0% by weight. In other embodiments, the enzyme component is present in an amount of about 0.01%, 0.05%, 0.1%, 0.15%, 0.2%, 0.5%, 1.0%, 1.5%, 2.0%, 2.5%, 3.0%, 3.5%, 4.0%, 4.5%, or 5.0% by weight.

In one embodiment, the enzyme contained in the washing or cleaning composition is a protease. Suitable proteases include, but are not limited to, SAVINASER sold by Novozymes A/S (a subtillase from Bacillus lentus), ALCALASER (bacterial protease), EVERLASER (protein-engineered variant of SAVINASER), ESPERASER (bacterial protease), and PROGRESS® UNO sold by Novozymes A/S (a new protease which is reported to be stable and compatible to various types of detergent products). Preferably, the protease is able to handle tough dirty conditions and deliver consistent wash performance—even in water-rich concentrations—and reduces or eliminates the need for stabilizers, as well as increasing formulation flexibility for detergent manufacturers. In some embodiments, the washing or cleaning composition of the present disclosure may contain another enzyme, to be used alone or together with a protease in the composition. The enzymes that may be added include those known in the art, such as amylolytic, proteolytic, cellulolytic or lipolytic type, and those listed in U.S. Pat. No. 5,958,864, the disclosure of which is incorporated herein by reference. Other enzymes include amylases, lipases and cellulases, such as LIPOLASE® (fungal lipase), LIPOLASE® ULTRA (Protein-engineered variant of LIPOLASE®), LIPOPRIME® (protein-engineered variant of LIPOLASE®), TERMAMYL® (bacterial amylase), BAN (Bacterial Amylase Novo), CELLUZYME® (fungal enzyme), and CAREZYME® (monocomponent cellulase), sold by Novozymes A/S. Additional enzymes of these classes suitable for use in accordance with the present disclosure will be well-known to those of ordinary skill in the art, and are available from a variety of commercial suppliers including but not limited to Novozymes A/S and Genencor/Danisco, and are considered to be within the scope of the invention.

### Builders

Other suitable components include organic or inorganic detergency builders. Examples of water-soluble inorganic builders that can be used, either alone or in combination with themselves or with organic alkaline sequestrant builder salts, are glycine, alkyl and alkenyl succinates, alkali metal carbonates, alkali metal bicarbonates, phosphates, polyphosphates and silicates. Specific examples of such salts are sodium tripolyphosphate, sodium carbonate, potassium carbonate, sodium bicarbonate, potassium bicarbonate, sodium pyrophosphate and potassium pyrophosphate. Examples of organic builder salts that can be used alone, or in combination with each other, or with the preceding inorganic alkaline builder salts, are alkali metal polycarboxylates, water-soluble citrates such as sodium and potassium citrate, sodium and potassium tartrate, sodium and potassium ethylenediaminetetracetate, sodium and potassium N(2-hydroxyethyl)-nitrilo triacetates, sodium and potassium N-(2-hydroxyethyl)-nitrilo diacetates, sodium and potassium oxydisuccinates, and sodium and potassium tartrate mono- and di-succinates, such as those described in U.S. Pat. No. 4,663,071, the disclosure of which is incorporated herein by reference.

In one embodiment, the builder component is selected from the group consisting of organic acids, alkali metal hydroxides, amines, and mixtures thereof. In yet another embodiment, the builder component is selected from the group consisting of citric acid, sodium hydroxide, sodium carbonate, sodium bicarbonate, calcium chloride, triethanolamine, monoethanolamine, and mixtures thereof, in an amount from about 1% to about 8% (e.g., about 1%, 2%, 3%, 4%, 5%, 6%, 7%, 8%, 9%, or 10% by weight).

### Foam Stabilizers

Suitable foam stabilizing agents include polyalkoxylated alkanolamides, amides, amine oxides, betaines, sultaines, C₈-C₁₈ fatty alcohols, and those disclosed in U.S. Pat. No. 5,616,781, the disclosure of which is incorporated by reference herein. Foam stabilizing agents are used, for example, in amounts of about 1 to about 20, typically about 3 to about 5% by weight. The composition can further include an auxiliary foam stabilizing surfactant, such as a fatty acid amide surfactant. Suitable fatty acid amides are C8-C20 alkanol amides, monoethanolamides, diethanolamides, and isopropanolamides.

### Colorants

In some embodiments, the washing or cleaning composition does not contain a colorant.

In some embodiments, the washing or cleaning composition contains one or more colorants. The colorant(s) can be, for example, polymers, dyes, water-soluble polymeric colorants, water-soluble dyes. The colorant(s) can be, for example, colorants that are well-known in the art or commercially available from dye or chemical manufacturers.

The total amount of the one or more colorant(s) that can be contained in the washing or cleaning composition, for example, can range from about 0.00001% by weight to about 0.099% by weight, or about 0.0001% by weight, about 0.001% by weight, about 0.01% by weight, about 0.05% by weight, or about 0.08% by weight.

### Dyes

All dyes suitable for use in laundry compositions can be used in the compositions of the present disclosure. In some embodiments, the solid composition comprises one or more dyes. In some embodiments, the liquid composition comprises one or more dyes. Suitable dyes include, but are not limited to chromophore types, e.g., azo, anthraquinone, triarylmethane, methine quinophthalone, azine, oxazine thiazine, which may be of any desired color, hue or shade, including those described elsewhere herein. Suitable dyes can be obtained from any major supplier such as Clariant, Ciba Speciality Chemicals, Dystar, Avecia or Bayer. In some embodiments, the dye is blue HP dye. In some embodiments, the dye is disperse violet 28 (DV28).

### Colorant Stabilizer(s)

In some embodiments, the washing or cleaning composition can optionally contain a colorant stabilizer, e.g., citric acid.

The total amount of the colorant stabilizer(s) in the washing or cleaning composition can range, for example, from about 0.01% by weight to about 5.0% by weight, or about 0.1% by weight, about 1% by weight, about 2% by weight, about 3% by weight, or about 4% by weight.

### Fragrance(s)

The washing or cleaning composition can optionally contain one or more fragrances (perfumes) suitable for use in laundry compositions. The fragrance can be contained for example, in an amount ranging from about 0.1% by weight to about 10% by weight, or about 0.2% by weight, about 0.3% by weight, about 0.4% by weight, about 0.5% by weight, about 0.6% by weight, about 0.7% by weight, about 0.8% by weight, about 0.9% by weight, about 1.0% by weight, about 2.0% by weight, about 3.0% by weight, about 4.0% by weight, about 5.0% by weight, about 6.0% by weight, about 7.0% by weight, about 8.0% by weight, or about 9.0% by weight.

As used herein, the term “fragrance” is used in its ordinary sense to refer to and include any fragrant substance or mixture of substances including natural (obtained by extraction of flowers, herbs, leaves, roots, barks, wood, blossoms, or plants), artificial (mixture of natural oils or oil constituents), and synthetically produced odoriferous substances. Typically, fragrances are complex mixtures of blends of various organic compounds such as alcohols, aldehydes, ethers, aromatic compounds and varying amounts of essential oils (e.g., terpenes) such as from 0% to 80%, usually from 1% to 70% by weight, of the essential oils themselves—being volatile odoriferous compounds and also serving to dissolve the other components of the fragrance.

The fragrance can have, for example, a musky scent, a putrid scent, a pungent scent, a camphoraceous scent, an ethereal scent, a floral scent, a peppermint scent, or any combination thereof. They can be free fragrance, encapsulated fragrance, or a combination thereof.

### Anti-Redeposition Polymers

All Anti-redeposition suitable for use in washing or cleaning compositions can be used in the compositions of the present disclosure. Anti-redeposition polymers are typically polycarboxylate materials, which can be prepared by polymerizing or copolymerizing suitable unsaturated monomers, are admixed in their acid form. Unsaturated monomeric acids that can be polymerized to form suitable polycarboxylates include acrylic acid, maleic acid (or maleic anhydride), fumaric acid, itaconic acid, aconitic acid, mesaconic acid, citraconic acid and methylenemalonic acid. The presence in the polycarboxylates herein of monomeric segments, containing no carboxylate radicals such as vinylmethyl ether, styrene, ethylene, etc. is suitable provided that such segments do not constitute more than about 40% by weight of the polymer.

Particularly suitable polycarboxylates can be derived from acrylic acid. In some embodiments, the anti-redeposition agent is an acrylic homopolymer having an average molecular weight between 3,000 and 6,000, between 3,000 and 5,000, between 3,000 and 4,500, between 3,000 and 4,000, between 4,000 and 6,000, between 4,000 and 5,000, between 4,000 and 4,500, between 4,500 and 6,000, between 4,500 and 5,000, or between 5,000 and 6,000. In some embodiments, the anti-redeposition agent is an acrylic homopolymer having an average molecular weight of about 4,500.

In some embodiments, the anti-redeposition agent is a copolymer comprising a hydrophobic polymer and a hydrophilic polymer. In some embodiments, the hydrophobic polymer in the copolymer is an acrylic acid, an amide, an imide, an ester, an ether, an olefin, a styrene, a vinyl acetal, a vinyl, a vinylidene chloride, a vinyl ester, a vinyl ether, a vinyl pyridine, or a vinyl pyrrolidone. In some embodiments, the hydrophilic polymer in the copolymer is an acrylic acid, an acrylamide, a maleic anhydride, an allyl amine, an ethylene imine, an oxazoline, an N-isopropyl acrylamide, a methyl acrylate, an ethylene glycol, an ethylene oxide, a vinyl alcohol, or a vinyl pyrrolidone.

In some embodiments, the anti-redeposition agent is an acrylic/styrene copolymer having an average molecular weight between 1,500 and 6,000. In some embodiments, the anti-redeposition agent is an acrylic/styrene copolymer having an average molecular weight of between 1,500 and 6,000, between 1,500 and 5,000, between 1,500 and 4,000, between 1,500 and 3,000, between 1,500 and 2,000, between 2,000 and 6,000, between 2,000 and 5,000, between 2,000 and 4,000, between 2,000 and 3,000, between 3,000 and 6,000, between 3,000 and 5,000, between 3,000 and 4,000, between 4,000 and 6,000, between 4,000 and 5,000, or between 5,000 and 6,000. In some embodiments, the anti-redeposition agent is an acrylic/styrene copolymer having an average molecular weight of about 3,000.

In some embodiments, the anti-redeposition agent is an acrylic/styrene copolymer, wherein the copolymer comprises between 1 and 95 parts acrylic acid and between 5 and 99 parts styrene. In some embodiments, the anti-redeposition agent is an acrylic/styrene copolymer, wherein the ratio of acrylic acid to styrene is between 20:80 and 95:5. In some embodiments, the anti-redeposition agent is an acrylic/styrene copolymer, wherein the ratio of acrylic acid to styrene is between 1:1 and 1:10.

Acrylic/maleic-based copolymers may also be used as an anti-redeposition agent. Such materials include the water-soluble salts of copolymers of acrylic acid and maleic acid. The average molecular weight of such copolymers in the acid form ranges from about 2,000 to 100,000, from about 5,000 to 75,000, or from about 7,000 to 65,000. The ratio of acrylate to maleate segments in such copolymers will generally range from about 30:1 to about 1:1, or from about 10:1 to 2:1. Water-soluble salts of such acrylic acid/maleic acid copolymers can include, for example, the alkali metal, ammonium and substituted ammonium salts.

Polyethylene glycol (PEG) can act as a clay soil removal anti-redeposition agent. Typical molecular weight ranges for these purposes range from about 500 to about, 100,000, from about 1,000 to about 50,000, from about 3,000 to about 10,000. Polyaspartate and polyglutamate dispersing agents may also be used.

Any polymeric soil release agent known to those skilled in the art can optionally be employed in compositions according to the invention. Polymeric soil release agents are characterized by having both hydrophilic segments, to hydrophilize the surface of hydrophobic fibers, such as polyester and nylon, and hydrophobic segments, to deposit upon hydrophobic fibers and remain adhered thereto through completion of washing and rinsing cycles and, thus, serve as an anchor for the hydrophilic segments. This can enable stains occurring subsequent to treatment with the soil release agent to be more easily cleaned in later washing procedures.

In some embodiments, the anti-redeposition agent is an acrylic polymer selected from SOKALAN® PA 30, SOKALAN® PA 20, SOKALAN® PA 15, and SOKALAN® CP 10 (BASF GmbH, Germany) and ACUSOL® 445G and ACUSOL® 445N (Dow Chemical Company, Midland, Mich.). In some embodiments, the anti-redeposition agent is an acrylic acid/maleic acid copolymer selected from ACUSOL® 460N and ACUSOL® 505N (Dow Chemical Company, Midland, Mich.) and SOKALAN® CP 5, SOKALAN® CP 45, and SOKALAN® CP 7 (BASF GmbH, Germany). In some embodiments, the anti-redeposition agent is an acrylic/methacrylic copolymer. In some embodiments, the anti-redeposition agent is an anionic polymer selected from ALCOSPERSE® 725, ALCOSPERSE® 726, and ALCOSPERSE® 747 (AkzoNobel, Chattanooga, Tenn.) and ACUSOL® 480N (Dow Chemical Company, Midland, Mich.). In some embodiments, the anti-redeposition agent is ACUSOL® 445G (Dow Chemical Company, Midland, Mich.). In some embodiments, the anti-redeposition agent is ACUSOL® 445N (Dow Chemical Company, Midland, Mich.). In some embodiments, the anti-redeposition agent is ALCOSPERSE® 747. In some embodiments, the anti-redeposition agent is DEQUEST SPE 1202 (Italmatch, Genova, Italy).

The amount of anti-redeposition polymer in the composition according to the present disclosure will be from about 0.01 to about 10%, from about 0.02 to about 8%, or from about 0.03 to about 6%, by weight of the composition.

In some embodiments, the anti-redeposition agent in the liquid composition is ALCOSPERSE® 747 (AkzoNobel, Chattanooga, Tenn.). In some embodiments, the anti-redeposition agent in the solid composition is ACUSOL® 445G (Dow Chemical Company, Midland, Mich.). In some embodiments, the anti-redeposition agent in the solid composition has been coated onto a powder carrier, such as sodium chloride, sodium sulfate, or combinations thereof.

### Other Ingredients

The compositions of the present disclosure optionally contain other ingredients that can typically be present in laundry or detergent products to provide further benefits in terms of cleaning power, solubilization, appearance, fragrance, etc. Other ingredients that can be included in the washing or cleaning composition are known to a person of ordinary skill in the art and include, but are not limited to a bittering agent, chelators, pH adjusting agents, pearlescers, opacifiers, fluorescers, optical brightening agents, pearlescers, anti-shrinking agents, anti-wrinkle agents, anti-spotting agents, germicides, fungicides, anti-corrosion agents, drape imparting agents, anti-static agents, ironing aids, crystal growth inhibitors, anti-oxidants, anti-reducing agents, viscosity modifiers, and preservatives.

In some embodiments, the compositions comprise a bittering agent such as denatonium benzoate, sold under the trade name of BITREX® (Johnson Matthey, London, United Kingdom).

### EXAMPLES

### Example 1

Protease Formulations with High and Low Surfactant Contents

Formulations were designed to remove proteinaceous and non-proteinaceous stains at high pH containing both high and low surfactants. High and low surfactant formulations were tested at pH 9 and pH 12, facilitated by the pH adjustment and buffering properties of sodium carbonate and sodium hydroxide. Table 1 is a high surfactant formulation, which contained 18.4% by weight total surfactants comprising alkylbenzene sulfonic acid, coconut fatty acid, C₁₂-C₁₅ alcohol ethoxylate (3EO), and alcohol ethoxylate (7EO). Three proteases (labeled as Enzyme 1, Enzyme 2, and Enzyme 3) were used, in amounts of 0.5% and 1.0% by weight, respectively.

TABLE 1
High surfactant formulations containing alkaline proteases

| | | 0.5% Protease | | | 1.0% Protease | |
|---|---|---|---|---|---|---|
| | | Enzyme | Enzyme | Enzyme | Enzyme | Enzyme |
| | | 1 | 2 | 3 | 1 | 3 |
| Material | Function | Active (%) | | | Active (%) | |
| Alkylbenzene sulfonic acid | Surfactant | 5.00 | 5.00 | 5.00 | 5.00 | 5.00 |
| (96%) | | | | | | |
| Cocofatty acid (100%) | Defoamer | 0.40 | 0.40 | 0.40 | 0.40 | 0.40 |
| C12-C15 Alcohol | Surfactant | 6.00 | 6.00 | 6.00 | 6.00 | 6.00 |
| Ethoxylate 3EO (60%) | | | | | | |
| Alcohol ethoxylate 7EO | Surfactant | 7.00 | 7.00 | 7.00 | 7.00 | 7.00 |
| (100%) | | | | | | |
| Enzyme (100%) | Protease | 0.50 | 0.50 | 0.50 | 1.00 | 1.00 |

Table 2 is a low surfactant formulation, which contained 5.6% by weight total surfactants comprising alkylbenzene sulfonic acid, coconut fatty acid, and C12-C15 alcohol ethoxylate (3EO) and alcohol ethoxylate (7EO). The proteases were tested in amounts of 0.5% and 1.0% by weight, respectively.

TABLE 2
Low surfactant formulations containing alkaline proteases

| | | 0.5% Protease | | | 1.0% Protease | |
|---|---|---|---|---|---|---|
| | | Enzyme | Enzyme | Enzyme | Enzyme | Enzyme |
| | | 1 | 2 | 3 | 1 | 3 |
| Material | Function | Active (%) | | | Active (%) | |
| Alkylbenzene | Surfactant | 3.00 | 3.00 | 3.00 | 3.00 | 3.00 |
| sulfonic acid | | | | | | |
| (96%) | | | | | | |
| Cocofatty | Defoamer | 0.10 | 0.10 | 0.10 | 0.10 | 0.10 |
| acid | | | | | | |
| (100%) | | | | | | |
| C12-C15 | Surfactant | 2.50 | 2.50 | 2.50 | 2.50 | 2.50 |
| Alcohol | | | | | | |
| Ethoxylate | | | | | | |
| 3EO (60%) | | | | | | |
| Alcohol | Surfactant | — | — | — | — | — |
| ethoxylate | | | | | | |
| 7EO (100%) | | | | | | |
| Enzyme | Protease | 0.50 | 0.50 | 0.50 | 1.00 | 1.00 |
| (100%) | | | | | | |

### Example 2

### Cleaning Performance of High and Low Surfactant Protease Formulations

Cleaning performance of the high and low surfactant protease formulations was tested against eight proteinaceous and non-proteinaceous stains. The proteinaceous stains evaluated were blood and grass. The non-proteinaceous stains evaluated were chocolate ice cream, coffee, dust sebum, grape juice, BBQ sauce, and mud.

Both proteinaceous and non-proteinaceous stains were made using standardized protocols and applied to the fabrics (cotton and woven blend, respectively). Stains were washed with 5.5 pound ballast loads in standard non-high efficiency 70 liter machines with water temperatures of approximately 90° F. The wash cycle included 12 minute wash and an approximately 8 minute rinse. Fabrics were then read on a spectrometer and the color differences reported as “delta E” value, which is the color difference between the tested formulations and a control formulation (i.e., the corresponding enzyme-free base formulation). A positive delta E value indicates the stain was removed at an amount greater than the control formulation. The higher the delta E value, the greater the cleaning performance. A value of delta E greater than or equal to 1.0 is an indication of strong stain removal. A negative delta E value indicates less stain removal performance as compared to the control.

The protease formulations with high surfactant and with an enzyme inclusion level of 0.5% by weight were tested against the control (i.e., enzyme free base product). The results were summarized in Table 3. The high “average cleaning” values indicate strong cleaning performance.

TABLE 3
Cleaning performance testing results of high surfactant formulations on two
fabrics (cotton and knitted blend) and eight stains.

| | | Cotton | | | Knitted Blend | | | Average Cleaning | | |
|---|---|---|---|---|---|---|---|---|---|---|
| | Stain | Enzyme | Enzyme | Enzyme | Enzyme | Enzyme | Enzyme | Enzyme | Enzyme | Enzyme |
| Stain | Class | 1 | 2 | 3 | 1 | 2 | 3 | 1 | 2 | 3 |
| Blood | Protein | 0.64 | 0.37 | −0.77 | 0.94 | 0.93 | 0.89 | 0.79 | 0.65 | 0.06 |
| Grass | Protein | 2.45 | 2.80 | 2.25 | 2.74 | 2.61 | 2.81 | 2.59 | 2.71 | 2.53 |
| Chocolate | Non- | 0.28 | 0.33 | 0.30 | 0.61 | 0.16 | 0.36 | 0.45 | 0.25 | 0.33 |
| Ice | Protein | | | | | | | | | |
| Cream | | | | | | | | | | |
| Coffee | Non- | −0.25 | −0.56 | −0.92 | 0.26 | −0.08 | 0.20 | 0.00 | −0.32 | −0.36 |
| | Protein | | | | | | | | | |
| Dust | Non- | −0.12 | −0.08 | −0.17 | 0.44 | 0.61 | 0.79 | 0.16 | 0.26 | 0.31 |
| Sebum | Protein | | | | | | | | | |
| Grape | Non- | −0.24 | −0.92 | −0.75 | 0.37 | −0.16 | 0.15 | 0.06 | −0.54 | −0.30 |
| Juice | Protein | | | | | | | | | |
| BBQ | Non- | 1.00 | 0.82 | 0.25 | 0.29 | 0.08 | 0.06 | 0.65 | 0.45 | 0.16 |
| Sauce | Protein | | | | | | | | | |
| Mud | Non- | −0.22 | −0.28 | −0.32 | 0.30 | 0.27 | 0.25 | 0.04 | 0.00 | −0.03 |
| | Protein | | | | | | | | | |

The protease formulations with low surfactant and with an enzyme inclusion level of 0.5% by weight against the control were also tested. The results are summarized in Table 4.

TABLE 4
Cleaning performance testing results of low surfactant formulations on two
fabrics and eight stains.

| | | Cotton | | | Knitted Blend | | | Average Cleaning | | |
|---|---|---|---|---|---|---|---|---|---|---|
| | Stain | Enzyme | Enzyme | Enzyme | Enzyme | Enzyme | Enzyme | Enzyme | Enzyme | Enzyme |
| Stain | Class | 1 | 2 | 3 | 1 | 2 | 3 | 1 | 2 | 3 |
| Blood | Protein | 2.09 | 1.95 | 0.85 | 1.29 | 1.26 | 1.26 | 1.69 | 1.60 | 1.06 |
| Grass | Protein | 1.20 | 0.85 | 1.21 | 3.10 | 3.27 | 2.80 | 2.15 | 2.06 | 2.01 |
| Chocolate | Non- | 0.56 | 0.46 | 0.60 | 0.31 | 0.23 | 0.30 | 0.44 | 0.34 | 0.45 |
| Ice Cream | Protein | | | | | | | | | |
| Coffee | Non- | 0.67 | 0.96 | −0.09 | 0.28 | 0.31 | 0.17 | 0.48 | 0.63 | 0.04 |
| | Protein | | | | | | | | | |
| Dust | Non- | −0.16 | 0.08 | 0.03 | 0.47 | 0.43 | 0.64 | 0.15 | 0.25 | 0.33 |
| Sebum | Protein | | | | | | | | | |
| Grape | Non- | 0.72 | 1.22 | 0.23 | 0.28 | 0.29 | 0.16 | 0.50 | 0.75 | 0.20 |
| Juice | Protein | | | | | | | | | |
| BBQ | Non- | 1.22 | 1.28 | 0.56 | 0.18 | 0.29 | 0.13 | 0.70 | 0.78 | 0.34 |
| Sauce | Protein | | | | | | | | | |
| Mud | Non- | 1.19 | 1.55 | 0.87 | 0.51 | 0.49 | 0.51 | 0.85 | 1.02 | 0.69 |
| | Protein | | | | | | | | | |

As shown in Table 4, the formulations containing Enzyme 1, Enzyme 2, or Enzyme 3 effectively removed the non-proteinaceous stains tested, especially the mud stain (average cleaning 0.85-1.02), which is surprising.

Also, when comparing the results in Tables 3 and 4, the low surfactant protease formulations removed more stain than the high surfactant protease formulations. The results were surprising as a low surfactant formulation was expected to have a lower cleaning performance than the high surfactant formulation by virtue of less detersive action.

### Example 3

### Cleaning Performance Enzyme 1 and Enzyme 3 Against Similar Active Level Competitive Benchmark Products at High and Low Surfactant Concentrations

Further cleaning performance tests were conducted by comparing formulations containing Enzyme 1 or Enzyme 3 (1.0% by weight) against similar active level competitive benchmark (“CB”) products. The tested formulations include both high and low surfactant concentrations and have pH of 12. Two high surfactant competitive CB products, CB1 and CB2, were included in the tests. CB1 contained no enzymes and had a pH of 11.90, while CB2 had a pH of 7.7 and contained 0.5% by weight of commercial protease. The results are summarized in Table 5.

TABLE 5
High surfactant formula cleaning performance on two fabrics and eight stains.

| | Stain | Cotton | | | | Blend | | | | Average Cleaning | | | |
|---|---|---|---|---|---|---|---|---|---|---|---|---|---|
| Stain | Class | CB1 | CB2 | V2 | V5 | CB1 | CB2 | V2 | V5 | CB1 | CB2 | V2 | V5 |
| Blood | Protein | 1.13 | −0.53 | 1.20 | 0.53 | 0.90 | 0.13 | 2.02 | 1.89 | 1.01 | −0.20 | 1.61 | 1.21 |
| Grass | Protein | 0.82 | 1.02 | 2.69 | 1.26 | 1.24 | 1.92 | 3.17 | 1.73 | 1.03 | 1.47 | 2.93 | 1.50 |
| Chocolate | Non- | 0.09 | 1.51 | 0.26 | 0.30 | −0.07 | 0.45 | 0.60 | 0.26 | 0.01 | 0.98 | 0.43 | 0.28 |
| Ice | Protein | | | | | | | | | | | | |
| Cream | | | | | | | | | | | | | |
| Coffee | Non- | 0.00 | 2.99 | 0.78 | 0.23 | 0.03 | 0.92 | 0.36 | −0.05 | 0.01 | 1.96 | 0.57 | 0.09 |
| | Protein | | | | | | | | | | | | |
| Dust | Non- | 0.89 | 0.44 | 0.36 | 0.43 | 0.70 | −0.97 | 0.28 | −0.07 | 0.80 | −0.26 | 0.32 | 0.18 |
| Sebum | Protein | | | | | | | | | | | | |
| Grape | Non- | 0.20 | 3.54 | 0.88 | 0.37 | 0.40 | 1.80 | 0.45 | 0.09 | 0.30 | 2.67 | 0.67 | 0.23 |
| Juice | Protein | | | | | | | | | | | | |
| BBQ | Non- | 0.79 | 1.32 | 1.43 | 0.65 | 0.27 | −0.03 | 0.33 | 0.01 | 0.53 | 0.65 | 0.88 | 0.33 |
| Sauce | Protein | | | | | | | | | | | | |
| Mud | Non- | 0.17 | 0.99 | 0.31 | 0.42 | 0.46 | 0.03 | 0.75 | 0.47 | 0.32 | 0.51 | 0.53 | 0.45 |
| | Protein | | | | | | | | | | | | |

Enzyme 1 is abbreviated as V2, and Enzyme 3 is abbreviated as V5. They were dosed at 1.0% *
* CB1 had a pH 12 with no enzymes, and CB2 had a pH 7.7 with 0.5% commercial enzyme.

As shown in Table 5, on average, the formulations containing Enzyme 1 or Enzyme 3 removed proteinacious stains more effectively than the CB products (average cleaning values of 1.21-2.93 vs. average cleaning values 0.20-1.47). The formulations containing Enzyme 1 performed better on removing non-proteinacious stains (grape juice, BBQ sauce and mud) than CB1. CB2 contained a chelator system which resulted in higher scores on removing grape juice and coffee stain (average cleaning values of 0.98-1.96). Chelators bind to the metals in stains thereby increasing stain removal. The formulations containing Enzyme 1 and Enzyme 3, as well as CB1 did not contain chelators.

Low surfactant formulations containing Enzyme 1 and Enzyme 3 (1.0% by weight) were also tested against three low active competitive benchmark products, CB3, CB4 and CB5. The protease containing low surfactant formulations contained about 5.5% by weight of surfactants. All three competitive benchmark products were enzyme free, had a pH about ≥10.5, and surfactant concentrations of approximately 10% by weight. The results are summarized in Table 6.

TABLE 6
Low surfactant formula cleaning performance on two fabrics and eight stains.

| | | Cotton | | | | | Knitted Blend | | | | | Average Cleaning | | | | |
|---|---|---|---|---|---|---|---|---|---|---|---|---|---|---|---|---|
| | Stain | CB | CB | CB | | | CB | CB | CB | | | CB | CB | CB | | |
| Stain | Class | 3 | 4 | 5 | V2 | V5 | 3 | 4 | 5 | V2 | V5 | 3 | 4 | 5 | V2 | V5 |
| Blood | Protein | 0.81 | 0.85 | −0.15 | 0.75 | 0.70 | 0.86 | 0.33 | 0.18 | 1.68 | 1.76 | 0.83 | 0.59 | 0.01 | 1.21 | 1.23 |
| Grass | Protein | 0.36 | 0.15 | 0.47 | 2.34 | 1.75 | 2.24 | 0.75 | 1.43 | 2.16 | 1.23 | 1.30 | 0.45 | 0.95 | 2.25 | 1.49 |
| Chocolate | Non- | 0.70 | −0.40 | 1.22 | 0.57 | 0.07 | 0.53 | 0.46 | 0.85 | 1.79 | 1.83 | 0.62 | 0.03 | 1.04 | 1.18 | 0.95 |
| Ice Cream | Protein | | | | | | | | | | | | | | | |
| Coffee | Non- | −0.07 | −0.38 | 1.04 | 0.30 | 0.75 | 0.33 | −0.23 | 0.76 | 0.31 | 0.34 | 0.13 | −0.31 | 0.90 | 0.30 | 0.54 |
| | Protein | | | | | | | | | | | | | | | |
| Dust | Non- | 2.17 | −0.04 | 2.68 | −0.07 | −0.16 | 2.12 | −0.11 | 2.34 | 0.42 | 0.04 | 2.14 | −0.07 | 2.51 | 0.17 | −0.06 |
| Sebum | Protein | | | | | | | | | | | | | | | |
| Grape | Non- | −0.53 | −1.01 | 0.43 | 0.48 | 0.52 | 0.19 | −0.19 | 0.46 | 0.29 | 0.52 | −0.17 | −0.60 | 0.45 | 0.38 | 0.52 |
| Juice | Protein | | | | | | | | | | | | | | | |
| BBQ | Non- | 0.48 | 0.21 | 0.36 | 1.18 | 0.88 | 0.58 | 0.17 | 0.30 | 0.17 | 0.15 | 0.53 | 0.19 | 0.33 | 0.67 | 0.51 |
| Sauce | Protein | | | | | | | | | | | | | | | |
| Mud | Non- | 0.64 | −0.03 | 0.64 | 0.49 | 0.35 | 1.15 | −0.24 | 0.91 | 0.58 | 0.08 | 0.89 | −0.13 | 0.78 | 0.54 | 0.22 |
| | Protein | | | | | | | | | | | | | | | |

Enzyme 1 is abbreviated as V2, and Enzyme 3 is abbreviated as V5. They were dosed at 1.0%**
**Competitive benchmark products CB3-CB5 had an approximately pH 10.5 or higher with no enzymes.

As shown in Table 6, the low surfactant formulations containing Enzyme 1 or Enzyme 3 cleaned more effectively on average than the CB products on proteinacious stains (average cleaning values of 1.21-2.25 vs. 0.45-1.30). The results are surprising as the formulations containing Enzyme 1 and Enzyme 3 contained approximately half the amount of surfactants as the competitive benchmark products.

Also, the formulations containing Enzyme 1 or Enzyme 3 performed significantly better on removing non-proteinacious stains (chocolate ice cream, coffee, dust sebum, grape juice, BBQ sauce and mud) than CB4.

### Example 4

### Cleaning Performance Testing of Savinase

Cleaning performance of a formulation containing savinase (Novozymes) was tested against a base formulation without enzyme. The stains were washed under the same conditions as described in Example 1. The base formulation had a surfactant concentration of 19% by weight, and a pH of 7.7. The results are summarized in Table 7.

TABLE 7
Cleaning performance testing results of Savinase

| | | Cotton | Knit Blend | Cleaning Average |
|---|---|---|---|---|
| Stain | Stain Class | Savinase | Savinase | Savinase |
| Blood | Protein | 0.195 | 1.03 | 0.61 |
| Grass | Protein | 2.35 | 2.46 | 2.41 |
| Chocolate Ice | Non-Protein | 0.24 | 0.06 | 0.16 |
| Cream | | | | |
| Coffee | Non-Protein | −0.42 | 0.13 | −0.15 |
| Dust Sebum | Non-Protein | 0.16 | 0.26 | 0.21 |
| Grape Juice | Non-Protein | 0.10 | 0.011 | 0.06 |
| BBQ Sauce | Non-Protein | 0.48 | 0.15 | 0.32 |
| Mud | Non-Protein | 0.32 | 0.20 | 0.27 |

As shown in Table 7, while the savinase containing formulation performed well on removing grass stain and fairly well on removing blood stain, but it did not perform well on removing any of the non-proteinacious stains.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A washing or cleaning composition suitable for removing proteinaceous and non-proteinaceous stains from a soiled fabric, comprising:
(a) a surfactant; and
(b) a protease,
wherein the composition has an alkaline pH.

2. The washing or cleaning composition of claim 1, wherein the composition is in a liquid, gel, or paste form.

3. The washing or cleaning composition of claim 1, wherein the pH is between about pH 9 to about pH 12.

4. The washing or cleaning composition of claim 1, wherein the surfactant is selected from the group consisting of an anionic surfactant, a cationic surfactant, a nonionic surfactant, a zwitterionic surfactant, an ampholytic surfactant, and a combination thereof.

5. The washing or cleaning composition of claim 4, wherein the surfactant is an anionic surfactant.

6. The washing or cleaning composition of claim 5, wherein the anionic surfactant is selected from the group consisting of a polyethoxylated alcohol sulfate, a water soluble salt of an alkyl benzene sulfonate having between 8 and 22 carbons in the alkyl group, an alkali metal salt of C₁₀₋₁₆ alkyl benzene sulfonic acids, a linear alkyl benzene sulfonate, a sodium or potassium linear straight chain alkylbenzene sulfonate, a salt of alkylsulfosuccinic acid, a fatty acid derivative of amino acids, a saturated fatty acid soap, and a combination thereof.

7. The washing or cleaning composition of claim 5, wherein the anionic surfactant is an alkyl benzene sulfonic acid.

8. The washing or cleaning composition of claim 1, wherein the surfactant is a nonionic surfactant.

9. The washing or cleaning composition of claim 8, wherein the nonionic surfactant is selected from the group consisting of an alkoxylated, ethoxylated, or propoxylated primary alcohol having from 8 to 18 carbon atoms and 1 to 12 moles of ethylene oxide (EO) and/or from 1 to 10 moles of propylene oxide (PO) per mole of alcohol, a fatty alcohol ethoxylate having more than 12 EO, an alkoxylated amine, an alkyl polyglycoside, an alkoxylated, ethoxylated, or ethoxylated and propoxylated fatty acid alkyl ester having 1 to 4 carbon atoms in the alkyl chain, an amine oxide, an alcohol ethoxylate, a nonylphenol ethoxylate, an alkylpolyglycoside, an alkyldimethylamineoxide, an ethoxylated fatty acid monoethanolamide, a fatty acid monoethanolamide, a fatty acid (polyhydroxyalkanol)amide, a N-acyl-N-alkyl derivative of glucosamine, and a combination thereof.

10. The washing or cleaning composition of claim 9, wherein the ethoxylated primary alcohol having 8 to 18 carbon atoms and an average of 1 to 12 moles of ethylene oxide (EO) per mol of alcohol is a C₁₂-C₁₅ alcohol ethoxylate 3EO, a C₁₂-C₁₅ alcohol ethoxylate 7EO, or a combination thereof.

11. The washing or cleaning composition of claim 1, wherein the surfactant is present in an amount of about 1 to about 25% by weight.

12. The washing or cleaning composition of claim 1, wherein the protease is present in an amount of about 0.1 to about 5% by weight.

13. The washing or cleaning composition of claim 1, wherein the composition additionally comprises one or more components selected from the group consisting of a defoamer, an anti-redeposition agent, a soil release polymer, a detergency builder, a biocidal agent, an enzyme, a perfume, a dye, a pH buffering agent, an optical brightener, a surfactant, a water-softening agent, a bleach, a solubilizer, and a stain-removing polymer.

14. The washing or cleaning composition of claim 13, wherein the defoamer is a cocofatty acid, and wherein the cocofatty acid is present in an amount of about 0.1 to about 5% by weight.

15. A unit dose laundry or cleaning composition, comprising:
(a) the washing or cleaning composition of claim 1; and
(b) a water-soluble film that forms one or more pouches encasing the cleaning composition.

16. A method of removing proteinaceous and non-proteinaceous stains from a soiled fabric, comprising:
(a) placing a soiled fabric into a washing chamber;
(b) placing the washing or cleaning composition of claim 1 into the washing chamber; and
(c) introducing water into the washing chamber and washing the fabric in an aqueous environment such that the washing or cleaning compositions contact the fabric and remove the stains from the fabric.

17. The method of claim 16, wherein the proteinaceous stain is a stain from blood, grass, milk, eggs, ink, body soils, baby formula, baby food, bodily fluids, cream, gelatin, cheese, pudding, and school glue.

18. The method of claim 16, wherein the non-proteinaceous stain is a stain from chocolate ice cream, coffee, dust sebum, grape juice, BBQ sauce, mud, alcoholic beverages, berries, fruit preserves, tomato juice, vegetable juice, maple syrup, molasses, tea, toothpaste, and wine.

19. The method of claim 16, wherein the washing chamber is a washing machine, a tergetometer, or an equivalent device.

20. The method of claim 16, wherein the method comprises removing stains by hand washing.
